(19) United States
(12) Patent Application Publication
(10) Pub. No.: US 2026/0140469 A1
(43) Pub. Date: May 21, 2026

(54) FIXING DEVICE AND IMAGE FORMING APPARATUS INCORPORATING THE SAME

(71) Applicant: Haruki OZAWA, Kanagawa (JP)

(72) Inventor: Haruki OZAWA, Kanagawa (JP)

(21) Appl. No.: 19/322,721

(22) Filed: Sep. 9, 2025

(30) Foreign Application Priority Data
Nov. 15, 2024 (JP) 2024-199344

(51) Int. Cl. G03G 15/20; F16H 55/06; F16H 55/08

(52) U.S. Cl. CPC G03G 15/206; F16H 55/06; F16H 55/08; G03G 15/2053; G03G 15/2064; G03G 2215/2035

(57) ABSTRACT

A fixing device includes a fixing belt, a heater, lubricant applied to the fixing belt, a pressure rotator pressed against the fixing belt, and a helical gear. The pressure rotator includes a shaft extending in an axial direction and rotates around the shaft in a rotation direction. The helical gear is disposed on one end of the shaft, is rotatable with the pressure rotator, and has gear teeth contacting one end of the fixing belt that faces the one end of the shaft in the axial direction to form a contact area. The tooth face is inclined with respect to the axial direction in the contact area. The tooth face has a first end farthest from a center of the shaft and a second end closer to the center than the first end in the axial direction. The second end is downstream from the first end in the rotation direction.

### CROSS-REFERENCE TO RELATED APPLICATION

This patent application is based on and claims priority pursuant to 35 U.S.C. § 119(a) to Japanese Patent Application No. 2024-199344, filed on Nov. 15, 2024, in the Japan Patent Office, the entire disclosure of which is hereby incorporated by reference herein.

### BACKGROUND

### Technical Field

The present disclosure relates to a fixing device that heats a toner image borne on the surface of a sheet to fix the toner image onto the sheet and an image forming apparatus including the fixing device, such as a copier, a printer, a facsimile machine, or a multifunction peripheral having at least two of copying, printing, and facsimile functions.

### Related Art

The image forming apparatus such as the copier or the printer includes the fixing device. One type of fixing device includes a fixing belt and a lubricant applied to an inner circumferential surface of the fixing belt to reduce wear of the inner circumferential surface of the fixing belt.

### SUMMARY

The present disclosure described herein provides a fixing device including a fixing belt, a heater, lubricant, a pressure rotator, and a helical gear. The heater heats the fixing belt. The lubricant is applied to an inner circumferential surface of the fixing belt. The pressure rotator is pressed against the fixing belt to form a fixing nip through which a sheet is conveyed and includes a shaft extending in an axial direction. The pressure rotator rotates around the shaft in a rotation direction. The helical gear has gear teeth. The helical gear is disposed on one end of the shaft of the pressure rotator and rotatable with the pressure rotator in the rotation direction. The gear teeth contact one end of the fixing belt that faces the one end of the shaft in the axial direction to form a contact area. Each of the gear teeth has a tooth face inclined with respect to the axial direction in the contact area. The tooth face has a first end farthest from a center of the shaft in the axial direction and a second end closer to the center than the first end in the axial direction. The second end is at a downstream side of the first end in the rotation direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an image forming apparatus;

FIG. 2 is a diagram illustrating a configuration of a fixing device;

FIG. 3 is a schematic cross-sectional view of the fixing device of FIG. 2 to illustrate parts extending in a width direction;

FIG. 4 is a schematic cross-sectional view of a fixing belt and flanges of the fixing device of FIG. 3 in a cross-section perpendicular to the surface of the paper on which FIG. 3 is drawn;

FIG. 5 is a cross-sectional view of a fixing device connected to a ground path;

FIG. 6 is a schematic view of an end of a part of the fixing device of FIG. 5 in an axial direction of a pressure roller;

FIG. 7 is a perspective view of the end of the part of FIG. 6;

FIG. 8A is a schematic diagram illustrating behavior of lubricant in a fixing device according to an embodiment of the present disclosure;

FIG. 8B is a schematic diagram illustrating behavior of lubricant in a fixing device according to a comparative example;

FIG. 9 is a diagram of a helical tooth of a helical gear;

FIGS. 10A to 10C are diagrams each schematically illustrating a helical tooth of a helical gear according to a first modification;

FIG. 11 is a cross-sectional view of a fixing device connected to a ground path according to a second modification; and

FIG. 12 is a cross-sectional view of a fixing device connected to a ground path according to a third modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to like elements or components and descriptions of those elements or components may be simplified or omitted.

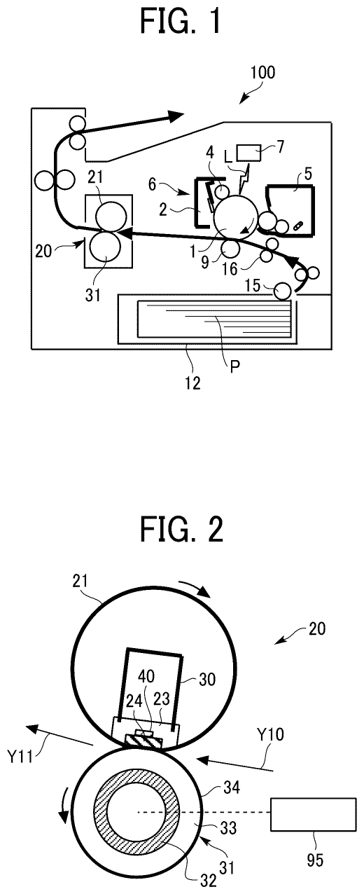

With reference to FIG. 1, the configuration and operation of an image forming apparatus 100 are described below.

In FIG. 1, the image forming apparatus 100 such as a small printer includes a process cartridge 6, an exposure device 7, a transfer roller 9, a sheet feeder 12, a registration roller pair 16 as a timing roller pair, and a fixing device 20. The process cartridge 6 is configured as a unit including a photoconductor drum 1, a charging roller 4, a developing device5, and a cleaning device 2. The exposure device 7 irradiates the photoconductor drum 1 with exposure light L that is generated based on image data input from an input device such as a personal computer. A toner image is formed on the photoconductor drum 1. The sheet feeder 12 includes a feed tray to store sheets P. The registration roller pair 16 conveys a sheet P toward a transfer nip where the photoconductor drum 1 and the transfer roller 9 contact each other. The transfer roller 9 transfers the toner image borne on the surface of the photoconductor drum 1 onto the sheet P conveyed to the transfer nip (that is, a transfer position). The fixing device 20 fixes the toner image that has not yet been fixed, to the sheet P.

The charging roller 4, the developing device 5, and the cleaning device 2 are arranged around the photoconductor drum 1. These members (the photoconductor drum 1, the charging roller 4, the developing device 5, and the cleaning device 2) are integrated as the process cartridge 6 and are detachably (replaceably) attached to the body of the image forming apparatus 100 as the apparatus body. After a user uses the process cartridge 6 for a predetermined replacement cycle, the user removes the process cartridge 6 from the body of the image forming apparatus 100 and replaces the process cartridge 6 with a new one.

With reference to FIG. 1, typical processes of the image forming apparatus 100 are described below.

The input device such as the personal computer sends the image data to the exposure device 7 in the image forming apparatus 100, and the exposure device 7 irradiates the surface of the photoconductor drum 1 with the exposure light (a laser beam) L based on the image data.

A drive motor disposed in the body of the image forming apparatus 100 rotates the photoconductor drum 1 in the direction indicated by the arrow in FIG. 1 (clockwise). Initially, the charging roller 4 uniformly charges the surface of the photoconductor drum 1 at a position at which the surface of the photoconductor drum 1 faces the charging roller 4, which is referred to as a charging process. As a result, a charging potential (for example, approximately −900 V) is formed on the surface of the photoconductor drum 1. Subsequently, the charged surface of the photoconductor drum 1 reaches an irradiation position of the exposure light L. An irradiated portion of the photoconductor drum 1 irradiated with the exposure light L has a latent image potential (from about 0 V to −100 V), and thus an electrostatic latent image is formed on the surface of the photoconductor drum 1, which is referred to as an exposure process.

After the exposure process, the surface of the photoconductor drum 1 on which the electrostatic latent image is formed reaches the position facing the developing device 5. The developing device 5 supplies toner onto the photoconductor drum 1 to develop the electrostatic latent image on the photoconductor drum 1 into a toner image, which is referred to as a developing process.

After the developing process, the surface of the photoconductor drum 1 bearing the toner image reaches a transfer nip (that is, a transfer position) formed between the photoconductor drum 1 and the transfer roller 9. In the transfer nip, a transfer bias having a polarity opposite the polarity of the toner is applied from a power source to the transfer roller 9, thereby transferring the toner image formed on the photoconductor drum 1 onto the sheet P conveyed by the registration roller pair 16, which is referred to as a transfer process.

The surface of the photoconductor drum 1 after the transfer process reaches a position opposite the cleaning device 2. At the position opposite the cleaning device 2, a cleaning blade mechanically removes untransferred toner remaining on the surface of the photoconductor drum 1, and removed toner is collected in the cleaning device 2, which is referred to as a cleaning process.

Thus, a series of image forming processes on the photoconductor drum 1 is completed.

The sheet P is conveyed to the transfer nip between the photoconductor drum 1 and the transfer roller 9 as follows.

First, a feed roller 15 feeds the uppermost sheet P of the stack of sheets P stored in the sheet feeder 12 toward a conveyance passage.

Subsequently, the sheet P reaches the registration roller pair 16. The sheet P that has reached the registration roller pair 16 is conveyed to the transfer nip (the contact position of the transfer roller 9 with the photoconductor drum 1) in synchronization with an entry of the toner image formed on the photoconductor drum 1 into the transfer nip.

After the sheet P passes through the transfer nip (i.e., the position of the transfer roller 9) in the transfer process, the sheet P reaches the fixing device 20 through the conveyance passage. In the fixing device 20, the sheet P is interposed between a fixing belt 21 and a pressure roller 31. The toner image is fixed on the sheet P by heat applied from the fixing belt 21 and pressure applied from both of the fixing belt 21 and the pressure roller 31, which is referred to as a fixing process. After the sheet P having the fixed toner image thereon is ejected from a fixing nip formed between the fixing belt 21 and the pressure roller 31, the sheet P is ejected from the body of the image forming apparatus 100 and stacked on an output tray.

Thus, a series of the image forming processes is completed.

With reference to FIGS. 2 to 7, the following describes a configuration and operation of the fixing device 20.

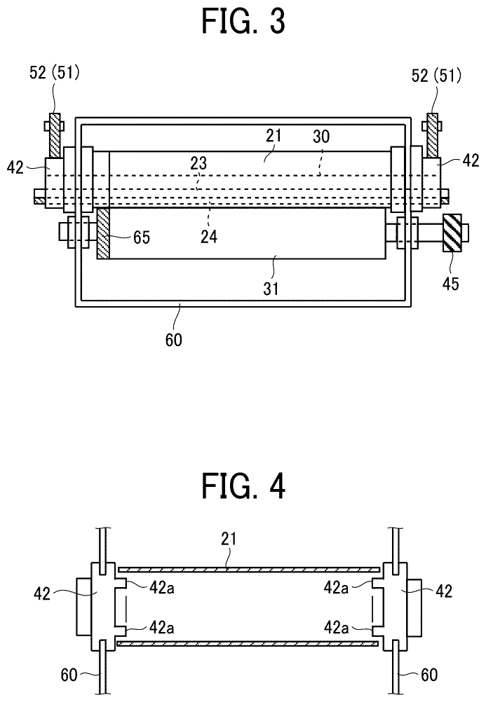

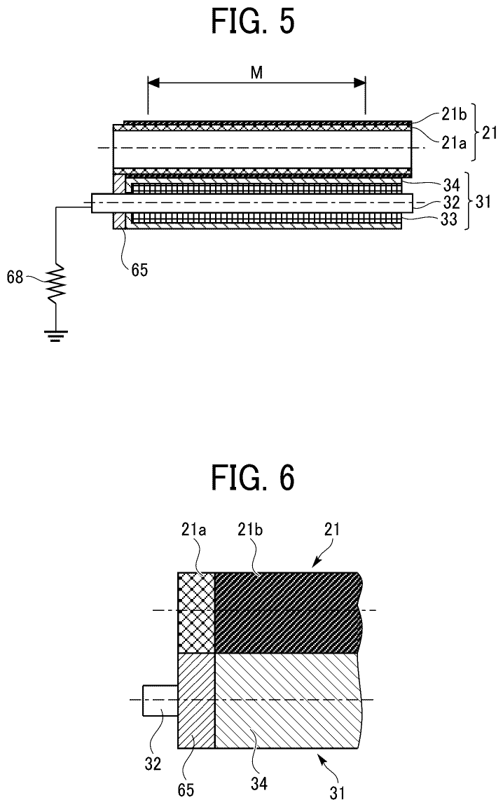

The fixing device 20 conveys the sheet P bearing an unfixed toner image while heating the sheet P. With reference to FIG. 2, the fixing device 20 includes the fixing belt 21 as a fixing rotator, a planar heater 24 as a heat source (a heating means), a holder 23, a stay 30, a thermistor 40, the pressure roller 31 as a pressure rotator, and a helical gear 65 as a ring (see FIGS. 3 and 5).

The fixing belt 21 is an endless belt disposed in contact with an outer circumferential surface of the pressure roller 31 and driven to rotate by rotation of the pressure roller 31. The fixing belt 21 is a thin, flexible, endless belt driven to rotate clockwise in FIG. 2, that is, in a rotation direction indicated by an arrow in FIG. 2. With reference to FIG. 5, the fixing belt 21 includes a base layer 21a as a belt conductive layer having an inner circumferential surface (i.e., a sliding contact surface of the fixing belt 21 sliding over the planar heater 24) and a belt surface layer 21b as a surface layer having an insulating property (or a medium resistance) and being layered on the base layer 21a. A total thickness of the fixing belt 21 is designed to be equal to or smaller than 1 mm.

The base layer 21a of the fixing belt 21 has a thickness in a range of from 30 μm to 50 μm. The base layer 21a is made of metal, such as nickel or stainless steel, or carbon-dispersed resin such as carbon-dispersed polyimide and functions as the belt conductive layer having conductivity.

The belt surface layer 21b of the fixing belt 21 has a thickness in a range of from 5 μm to 50 μm. The belt surface layer 21b is made of an insulating material such as tetrafluoroethylene-perfluoroalkyl vinyl ether copolymer (PFA), polytetrafluoroethylene (PTFE), polyimide, polyether imide, and polyether sulfone (PES). The belt surface layer 21b having the insulating property facilitates the separation of toner contained in the toner image on the sheet P from the fixing belt 21.

In the above, the belt surface layer 21b is made of an insulating material but may be made of a material having the medium resistance by dispersing a relatively small amount of carbon in the above-described insulating material. The specific resistance value range of the medium resistance is equal to or greater than 10⁷ Ω/□ and less than 10¹⁰ Ω/□. As a result, the belt surface layer 21b has a resistance larger than the base layer 21a as the belt conductive layer.

Inside the loop of the fixing belt 21, the planar heater 24, the holder 23, the stay 30, and the thermistor 40 are disposed The planar heater 24 is disposed so as to extend in a width direction that is a direction perpendicular to the surface of the paper on which FIG. 2 is drawn, the lateral direction in each of FIGS. 3 to 6, and an axial direction of the pressure roller 31. The planar heater 24 contacts the inner circumferential surface of the fixing belt 21. The planar heater 24 is pressed against the pressure roller 31 via the fixing belt 21 to form the fixing nip through which the sheet P is conveyed. The planar heater 24 is disposed inside the loop formed by the fixing belt 21 such that the inner circumferential surface of the fixing belt 21 slides over the planar heater 24. Pressing the planar heater 24 against the pressure roller 31 via the fixing belt 21 forms the fixing nip between the fixing belt 21 and the pressure roller 31, through which the sheet P is conveyed. As described above, the planar heater 24 functions as a nip formation pad that is a member forming the fixing nip.

In addition, the planar heater 24 includes a resistor pattern (in other words, a resistive heat generator) formed on a portion that is in sliding contact with the inner circumferential surface of the fixing belt 21. A power supply supplies electric power to the resistor pattern, and the resistor pattern generates heat according to the resistance of the resistor pattern to heat the fixing belt 21. As described above, the planar heater 24 also functions as a heater (in other words, a heat source or a heating device) to heat the fixing belt 21.

To reduce sliding friction between the inner circumferential surface of the fixing belt 21 and the planar heater 24, a lubricant such as silicon oil or fluorine grease is directly applied to the inner circumferential surface of the fixing belt 21.

Instead of directly applying the lubricant to the inner circumferential surface of the fixing belt 21, the lubricant may be indirectly applied to the inner circumferential surface of the fixing belt 21 by applying the lubricant to the sliding contact surface of the planar heater 24 on which the fixing belt 21 slides.

In addition to applying the lubricant to the inner circumferential surface of the fixing belt 21, the planar heater 24 may include a surface layer or a sheet made of a low friction material such as PTFE on the surface of the planar heater 24.

The holder 23 holds the planar heater 24. The holder 23 has a recess, and the planar heater 24 is fitted into the recess to hold the planar heater 24 in the width direction. The stay 30 holds the holder 23 holding the planar heater 24. The fixing device 20 includes a frame 60. The frame 60 holds both ends of the stay 30 holding the planar heater 24 and the holder 23 in the width direction via flanges 42 (see FIG. 3).

As described above, the planar heater 24 (the resistor pattern) disposed inside the loop of the fixing belt 21 directly heats the fixing belt 21. The outer circumferential surface of the fixing belt 21 heated by the planar heater 24 heats the toner image on the sheet P.

The output of the planar heater 24 is controlled based on the temperature of the planar heater 24 detected by the thermistor 40. The thermistor 40 directly contacts the planar heater 24 (or indirectly contacts the planar heater 24 via another member). The fixing device 20 according to the present embodiment does not include a temperature sensor that directly detects the surface temperature of the fixing belt 21. A controller controls the temperature of the planar heater 24 detected by the thermistor 40 to indirectly control the surface temperature (that is a fixing temperature) of the fixing belt 21 to a desired temperature.

With reference to FIG. 4, a pair of flanges 42 guides ends of the inner circumferential surface of the fixing belt 21 in the width direction of the fixing belt 21 such that the fixing belt 21 maintains a substantially cylindrical posture.

Specifically, the two flanges 42 are made of a heat-resistant resin material and are held by both sides of the frame 60 in the width direction of the frame 60 of the fixing device 20 so that each of the flanges 42 can slide and move along each of the sides of the frame 60 in a direction forming the fixing nip. Each of the flanges 42 includes a guide 42a and a stopper. The guides 42a hold the fixing belt 21 to maintain the substantially cylindrical posture of the fixing belt 21. The stopper restricts motion or skew of the fixing belt 21 in the width direction of the fixing belt 21.

As illustrated in FIG. 3, the fixing device 20 includes pressing levers 52 of a pressing device 51. The pressing levers press the flanges 42 such that the fixing belt 21, the planar heater 24, and the holder 23 press the pressure roller 31. The flanges 42 are disposed to support both ends of the loop of the fixing belt 21 in the width direction except for portions facing both ends of the fixing nip so that the planar heater 24 can form the fixing nip. The inner circumferential surface of the fixing belt 21 is loosely contacted only by the planar heater 24 and the flanges 42 at respective ends of the fixing belt 21 in the width direction thereof. No other component, such as a belt guide, contacts the inner circumferential surface of the fixing belt 21 to guide the fixing belt 21 as it rotates.

The fixing device 20 includes the stay 30 that is disposed inside the loop of the fixing belt 21 so as to be in contact with the pressure roller 31 via the holder 23, the planar heater 24, and the fixing belt 21. The stay 30 reinforces the planar heater 24 forming the fixing nip (and the holder 23), enhancing the mechanical strength of the holder 23 and the planar heater 24. The stay 30 is assembled to the frame 60 (or the holder 23) by screw fastening or other fasteners.

The stay 30 contacts the pressure roller 31 via the holder 23, the planar heater 24, and the fixing belt 21 to receive the pressure from the pressure roller and prevents a disadvantage that the pressure from the pressure roller 31 largely deforms the planar heater 24 (and the holder 23) at the fixing nip. Preferably, the stay 30 is made of metal having an increased mechanical strength, such as stainless steel or iron, to achieve the above-described function.

The holder 23 may be made of resin or metal. Preferably, the holder 23 is made of resin that has rigidity to prevent the holder 23 from bending even if the holder 23 receives pressure from the pressure roller 31, and the resin preferably has heat resistance and thermal insulation. The resin may be liquid crystal polymer (LCP), polyamide imide (PAI), polyether sulfone (PES), polyphenylene sulfide (PPS), polyether nitrile (PEN), and polyether ether ketone (PEEK). The holder 23 according to the present embodiment is made of liquid crystal polymer (LCP).

With reference to FIG. 2, the pressure roller 31 as the pressure rotator includes a cored bar 32 serving as a shaft extending in the axial direction, an elastic layer 33 layered on the cored bar 32, and a conductive surface layer 34 layered on the elastic layer 33. The pressure roller 31 is driven and rotated counterclockwise in FIG. 2 by a drive motor 95.

The cored bar 32 (the shaft) of the pressure roller 31 has a hollow structure made of metal (the conductive material). The elastic layer 33 of the pressure roller 31 is made of an insulating material such as silicone rubber foam, silicone rubber, or fluororubber.

The conductive surface layer 34 of the pressure roller 31 is thin and functions as a release layer. The conductive surface layer 34 is made of PFA or PTFE in which carbon is dispersed to have conductivity. The material of the conductive surface layer 34 has a tubular shape. The material of the conductive surface layer 34 is set on the elastic layer 33 so that the tube covers the elastic layer 33. Thermal processing is performed to form the conductive surface layer 34.

The pressure roller 31 is pressed against the fixing belt 21 to form a desired nip (the fixing nip) between the fixing belt 21 and the pressure roller 31. As illustrated in FIG. 3, a gear 45 is attached to the pressure roller 31 and engages a driving gear of the drive motor so that the pressure roller 31 is driven and rotated counterclockwise in FIG. 2, that is, a direction indicated by the arrow in FIG. 2. Both ends of the pressure roller 31 in the width direction are rotatably supported by the frame 60 of the fixing device 20 through bearings, respectively.

The fixing device 20 according to the present embodiment also includes the helical gear 65 as the ring, which will be described in detail below.

A description is provided of a regular fixing process to fix the toner image on the sheet P, which is performed by the fixing device 20 having the construction described above.

When the controller in the image forming apparatus 100 receives a print instruction, the controller controls the power supply to supply the electric power to the planar heater 24 and controls the drive motor 95 to start rotating the pressure roller 31 in the direction indicated by the arrow in FIG. 2. Due to driving and rotating the pressure roller 31, friction between the pressure roller 31 and the fixing belt 21 at the fixing nip rotates the fixing belt 21 in a direction indicated by an arrow in FIG. 2.

After the fixing belt 21 rotates, the sheet P is fed from the sheet feeder 12, and the toner image is transferred onto the sheet P at the position of the transfer roller 9. As a result, the sheet P bears an unfixed toner image. As illustrated in FIG. 2, the sheet P bearing the unfixed toner image is conveyed in a direction indicated by an arrow Y10 while the sheet P is guided by the entrance guide plate and enters the fixing nip formed between the fixing belt 21 and the pressure roller 31 pressed against the fixing belt 21.

The planar heater 24 heats the fixing belt 21. The planar heater 24 and the holder 23 are reinforced by the stay 30 and pressed against the pressure roller 31. The heat in the fixing belt 21 and the pressure between the planar heater 24 and the pressure roller 31 fix the toner image on the surface of the sheet P. After the toner image is fixed on the surface of the sheet P, the sheet P is sent out from the fixing nip, and an exit guide plate guides the sheet P to be conveyed in a direction indicated by an arrow Y11 in FIG. 2.

The following describes the configuration and operation of the fixing device 20 in detail, which is characteristic of the image forming apparatus 100 according to the present embodiment.

As described above with reference to FIGS. 2 and 5, the lubricant is directly (or indirectly) applied to the inner circumferential surface of the fixing belt 21 as the belt, and the planar heater 24 as the heater heats the fixing belt 21.

The fixing belt 21 includes the base layer 21a as the belt conductive layer having conductivity. In addition, the fixing belt 21 includes the belt surface layer 21b having the insulating property (or the belt surface layer having the medium resistance) directly layered on the base layer 21a (the belt conductive layer).

In other words, the fixing belt 21 according to the present embodiment has a two layer structure including the base layer 21a as the belt conductive layer having conductivity and the belt surface layer 21b having the insulating property or the medium resistance and layered on the base layer 21a.

In particular, the fixing belt 21 is formed so that one end of the base layer 21a (the belt conductive layer) in the width direction that is a left end of the base layer 21a in FIG. 5 projects from one end of the belt surface layer 21b in the width direction, and the helical gear 65 described below is disposed on the above-described one end of the base layer 21a. The above-described one end of the base layer 21a (the belt conductive layer) projecting from the above-described one end of the belt surface layer 21b in the width direction directly contacts the helical gear 65 as the ring described below to form a contact area. In other words, gear teeth of the helical gear 65 contact one end of the fixing belt 21 in the axial direction of the pressure roller 31 to form the contact area. As a result, the belt surface layer 21b is layered on a part of the base layer 21a (the belt conductive layer) extending in the width direction (the lateral direction in FIGS. 5 and 6 and the axial direction) other than the one end of the fixing belt 21 facing the contact area formed by the gear teeth of the helical gear 65 described below and the base layer 21a contacting each other.

On the other hand, the pressure roller 31 as the pressure rotator includes the conductive surface layer 34 that has the conductivity and is in contact with the belt surface layer 21b of the fixing belt 21 as the fixing rotator to form the fixing nip.

As illustrated in FIGS. 5 to 7 and 8A, the helical gear 65 as the ring is disposed on one end of the shaft of the pressure roller 31 as the pressure rotator of the fixing device 20 according to the present embodiment. The helical gear 65 is electrically conductive and grounded. The helical gear 65 comes into contact with the base layer 21a (the belt conductive layer) of the fixing belt 21 and the conductive surface layer 34 and is electrically connected to the base layer 21a and the conductive surface layer 34.

Specifically, as illustrated in FIGS. 5 to 8A, the helical gear 65 has a ring shape (in other words, a doughnut shape) and is made of a conductive material. However, the helical gear 65 does not have a complete ring shape. The helical gear 65 has multiple helical tooth-shaped projections 65a as helical teeth on the entire outer peripheral portion of the helical gear 65 in the circumferential direction. The helical gear 65 as the ring has a shape like a gear but does not function as a gear transmitting a driving force. The helical gear 65 functions as a conductor grounding the base layer 21a (the belt conductive layer) of the fixing belt 21 and the conductive surface layer 34.

The helical gear 65 as the ring also functions as a lubricant leakage preventing member that prevents the lubricant applied to the inner circumferential surface of the fixing belt 21 from leaking from the end of the fixing belt 21, which is described in detail below.

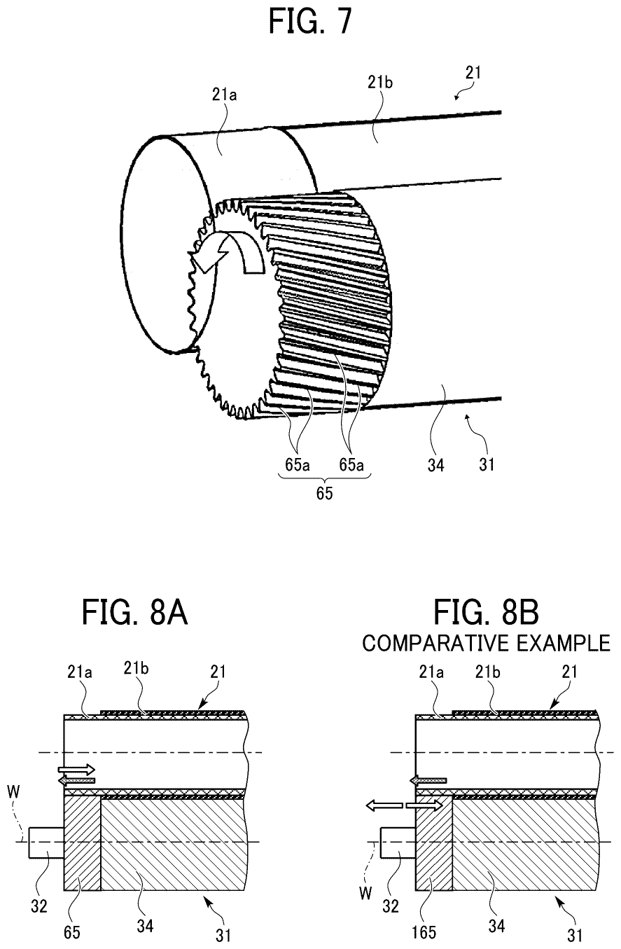

To be more specific, the helical gear 65 as the ring is made of conductive rubber. The helical gear 65 has the multiple helical tooth-shaped projections 65a inclined with respect to the axial direction on the entire outer peripheral portion of the helical gear 65 in the circumferential direction (see FIG. 7). The helical tooth-shaped projection 65a is configured (designed) similarly to a helical tooth of a so-called helical gear.

The cored bar 32 of the pressure roller 31 is inserted into the helical gear 65. In other words, the helical gear 65 is disposed on the cored bar 32 of the pressure roller 31 so as to contact the base layer 21a (the belt conductive layer) of the fixing belt 21 and the end face of the roller body of the pressure roller 31. The cored bar 32 functions as the shaft of the end of the pressure roller 31. The helical gear 65 rotates in a predetermined direction (counterclockwise in FIG. 2) together with the pressure roller 31.

In order to obtain a sufficient contact area in which the conductive surface layer 34 of the pressure roller 31 is in contact with the helical gear 65, one end of the conductive surface layer 34 in the axial direction (in other words, one end in the width direction) has a shape folded in the radial direction and extending along an end face of the elastic layer 33 as illustrated in FIG. 5. The portion of the conductive surface layer 34 having the shape folded in the radial direction contacts the end face of the helical gear 65.

The helical gear 65 has an outer diameter (an addendum circle diameter) substantially equal to or slightly larger than the outer diameter of the roller body (that includes the elastic layer 33 and the conductive surface layer 34) of the pressure roller 31. The helical gear 65 contacts the base layer 21a of the fixing belt 21 (specifically, the above-described one end of the base layer 21a projecting from the above-described one end of the belt surface layer 21b in the width direction). Even if the outer diameter(the addendum circle diameter) of the helical gear 65 is equal to the outer diameter of the roller body of the pressure roller 31, the helical gear 65 (the helical tooth-shaped projections 65a) contacts the base layer 21a (the belt conductive layer) and is electrically connected to the base layer 21a. This is because the belt surface layer 21b is extremely thin and the pressure roller 31 is pressed against the fixing belt 21 so as to deform the fixing belt 21 and the pressure roller 31.

The ring contacting the base layer 21a (the belt conductive layer) of the fixing belt 21 in the present embodiment does not have a perfect ring shape but has a gear shape (a helical gear shape in the present embodiment). The multiple gear teeth (the multiple helical tooth-shaped projections 65a) arranged at intervals in the circumferential direction intermittently contacts the base layer 21a. The ring having the multiple gear teeth is less likely to cause a contact failure such as a partial contact than the ring having a perfect ring shape and contacting the base layer 21a. As a result, the ring having the multiple gear teeth generates satisfactorily, stably, and relatively large contact pressure and stably electrically couples between the base layer 21a and the ring.

The helical gear 65 is press-fitted into the cored bar 32 to enhance conductivity (electrical connectivity) with the cored bar 32 as the shaft. In order to prevent the helical gear 65 from being displaced on the cored bar 32 in the width direction (the axial direction), the helical gear 65 may be bonded and fixed to the cored bar 32 by a conductive adhesive.

As illustrated in FIG. 5, the helical gear 65 is grounded (earthed) via the cored bar 32. Specifically, the cored bar 32 is connected to a grounding wire including the frame 60 grounded via a resistor 68 (an electric resistance member). Thus, the helical gear 65 is favorably grounded.

The helical gear 65 is disposed outside a maximum sheet passing region M in the fixing device 20 (in other words, disposed in a non-sheet passing region). The maximum sheet passing region M is defined as a region in the width direction through which a sheet P having a maximum size that can be conveyed passes. As a result, the helical gear 65 does not contact the fixed image and does not affect the fixed image.

As described above, the fixing device 20 according to the present embodiment includes the helical gear 65 functioning as the conductor. The helical gear 65 grounded is satisfactorily and electrically connected to the base layer 21a (the belt conductive layer) of the fixing belt 21 and the conductive surface layer 34 of the pressure roller 31. The above-described structure is less likely to accumulate electric charge in the fixing belt 21 and the pressure roller 31 and reduces the occurrence of an abnormal image such as an electrostatic offset caused by the electric charge accumulation.

The electrostatic offset occurs as follows in the fixing process. When the sheet P that bears the toner enters the fixing nip, the toner electrostatically moves and adheres to the fixing belt 21 as the fixing rotator. After the fixing belt 21 rotates once, the toner adhered to the fixing belt 21 adheres to the sheet P again. As a result, the electrostatic offset occurs.

The above-described movement of toner to the fixing belt 21 is caused by charge on the surfaces of the fixing belt 21 and the pressure roller 31. In the present embodiment, the toner is negatively charged. When the fixing belt 21 is positively charged, the toner receives an electrostatic adsorptive force from the fixing belt 21. When the pressure roller 31 is negatively charged, the toner receives an electrostatic repulsive force from the pressure roller 31. As a result, the toner adheres to the fixing belt 21.

To countermeasure the above-described phenomenon, in the fixing device 20 according to the present embodiment, the charge is removed from the base layer 21a (the belt conductive layer) of the fixing belt 21 and the conductive surface layer 34 of the pressure roller 31 as described above. As a result, the surfaces of the fixing belt 21 and the pressure roller 31 are less likely to be charged. Therefore, electrostatic offset is less likely to occur.

As illustrated in FIGS. 7 and 8A, the helical gear 65 as the ring in the fixing device 20 includes the helical tooth-shaped projections 65a (the helical teeth) inclined. When the helical gear 65 rotates together with the pressure roller 31 as the pressure rotator, the inclined helical tooth-shaped projections 65a generate a thrust force toward the center of the fixing belt 21 in the axial direction of the pressure roller 31 (that is the lateral direction in FIG. 8A and the width direction). The thrust force acts on the fixing belt 21 in the contact area in which the helical gear 65 contacts the fixing belt 21 (in other words, the contact area in which the helical gear 65 contacts the base layer 21a exposed on one end of the fixing belt 21 in the width direction).

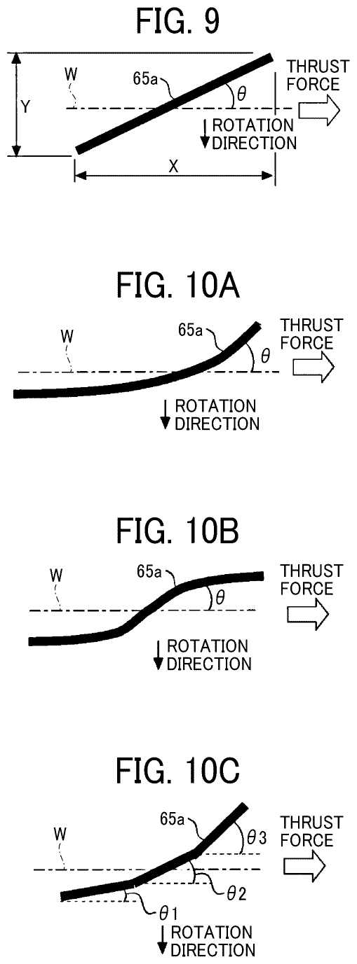

FIG. 9 is a schematic diagram of the helical tooth-shaped projection 65a as a tooth of the helical gear 65 on the contact area in which the helical gear 65 contacts the base layer 21a of the fixing belt 21 when viewed from the base layer 21a. As illustrated in FIG. 9, a tooth face of the helical tooth-shaped projection 65a that is the downstream side of the helical tooth-shaped projection 65a in the rotation direction of the pressure roller 31 generates the thrust force acting on the fixing belt 21 in the contact area toward the center of the fixing belt 21 in the axial direction (toward the right side in FIGS. 8A and 9), not toward the outside of the fixing belt 21 in the axial direction (not toward the left side in FIGS. 8A and 9), in a direction indicated by the white arrow in FIG. 9. In other words, each of the gear teeth of the helical gear 65 has the tooth face inclined with respect to the axial direction in the contact area. As illustrated in FIG. 9, the tooth face has a left end as a first end farthest from the center of the shaft and a right end as a second end closer to the center than the first end in the axial direction, and the right end is at a downstream side of the left end in the rotation direction. The above-described thrust force is generated when an angle θ (helix angle) formed by the tooth face that is the downstream side in the rotation direction and the axis W extending in the axial direction is larger than 0 degrees and smaller than 90 degrees.

Since the helical gear 65 is pressed against the base layer 21a of the fixing belt 21, the helical tooth-shaped projections 65a (the helical teeth) deform the inner circumferential surface of one end of the base layer 21a. The shapes of the helical tooth-shaped projections 65a rotating appear in the inner circumferential surface, and projections having the helical gear shape and projecting toward the center of the rotation appear on the inner circumferential surface of the base layer 21a, which generates the thrust force in the direction indicated by the white arrow in FIG. 8A that moves the lubricant on the inner circumferential surface of the fixing belt toward the center of the fixing belt 21 in the width direction. Even if the lubricant applied to the inner circumferential surface of the fixing belt 21 moves along the fixing nip and toward the outside of the fixing belt 21 in the width direction (moves in the direction indicated by the black arrow in FIG. 8A), the thrust force acts on the lubricant on the inner circumferential surface of the fixing belt 21 to return the lubricant to the center of the fixing belt 21 in the width direction. The above-described structure prevents the lubricant applied to the inner circumferential surface of the fixing belt 21 from leaking outward in the width direction of the fixing belt 21.

FIG. 8B is a schematic diagram illustrating behavior of lubricant in a fixing device including a spur gear 165 as the ring according to a comparative example. The spur gear 165 is pressed against the base layer 21a but does not generate the thrust force that moves the lubricant toward the center of the fixing belt 21 in the width direction. As a result, the lubricant applied to the inner circumferential surface of the fixing belt 21 moves along the fixing nip and toward the outside of the fixing belt in the width direction (moves toward the direction indicated by the black arrow in FIG. 8B) and leaks from the outside of the fixing belt in the width direction. The lubricant that has leaked to the outside of the fixing belt 21 is scattered in the directions of the white arrows in FIG. 8B and adheres to other components, causing abnormalities in the fixed image or soiling the outside of the fixing device. The spur gear 165 illustrated in FIG. 8B, as the ring, functions as a junction component (in other words, the conductor) of a ground wire to ground the base layer 21a of the fixing belt 21 and the conductive surface layer 34 of the pressure roller 31, which is the same as the helical gear 65 in the present embodiment. The lubricant adhering to the spur gear 165 as the ring reduces the conductivity between the spur gear 165 and the base layer 21a and the conductivity between the spur gear 165 and the conductive surface layer 34. In other words, the lubricant adhering to the spur gear 165 reduces the function of the spur gear 165 as the junction component (the conductor). As a result, the electrostatic offset occurs in the fixed image.

In contrast, the helical gear 65 in the present embodiment prevents the lubricant applied to the inner circumferential surface of the fixing belt 21 from leaking outward in the width direction of the fixing belt 21. As a result, the helical gear 65 in the present embodiment is less likely to cause the disadvantage that the leaked lubricant adheres to the helical gear 65 and reduces the function as the junction component (the conductor).

As described above, the fixing belt 21 according to the present embodiment has the two layer structure including the belt surface layer 21b layered on the base layer 21a. The two layer structure is more likely to reflect the shape of the helical tooth-shaped projections 65a on the inner circumferential surface of the base layer 21a with which the helical gear 65 is in pressure contact than a three layer structure including an elastic layer formed between the base layer 21a and the belt surface layer 21b. Accordingly, the two layer structure is likely to exhibit the above-described effect reducing the lubricant leaking outward in the width direction.

In the present embodiment, the helical gear 65 as the ring is disposed on one end of the pressure roller 31 in the width direction. On the other end of the pressure roller 31 in the width direction, the gear 45 engaging the driving gear of the drive motor is disposed (see FIG. 3), forming a driven portion. The above-described one end of the pressure roller 31 is referred to as a non-driven portion. The driven portion vibrates, and the vibration of the driven portion causes the lubricant to easily flow from a portion of the fixing belt 21 adjacent to the driven portion to a portion of the fixing belt 21 adjacent to the non-driven portion. As a result, the lubricant easily leaks from the outside of the fixing belt 21 adjacent to the non-driven portion in the width direction. The structure including the helical gear 65 disposed on the non-driven portion is useful.

As illustrated in FIG. 8A, a position of an edge of the fixing belt 21 in the width direction that is the same as the axial direction substantially coincides with a position of an edge of the helical gear 65 as the ring in the axial direction. In other words, the end of the tooth face farthest from the center of the shaft of the pressure roller 31 is aligned at an edge of the above-described one end of the fixing belt in the axial direction.

In other words, the outermost edge face of the helical tooth-shaped projections 65a is not located outside or inside the edge of the fixing belt 21 in the width direction but is substantially in the same plane with the edge of the fixing belt 21 in the width direction.

This is because the helical gear 65 including the helical tooth-shaped projections 65a having the outermost edge outside the edge of the fixing belt 21 in the width direction is directly heated by the planar heater 24 extending outside from the edge of the fixing belt 21 in the width direction, and thus, the helical gear 65 is likely to be thermally damaged.

In addition, this is because the helical gear 65 including the helical tooth-shaped projections 65a having the outermost edge inside the edge of the fixing belt 21 in the width direction reduces an area of the inner circumferential surface of the base layer 21a which the helical gear 65 is pressed against to reflect the shape of the helical tooth-shaped projections 65a, and thus, the effect reducing the lubricant that leaks to the outside of the fixing belt 21 is reduced.

The contact area on which the helical gear 65 as the ring is in contact with the base layer 21a has a nip width Y illustrated in FIG. 9 that is a length of the contact area in a direction perpendicular to the surface of the paper on which FIG. 8A is drawn. At least one helical tooth-shaped projection 65a is positioned in the contact area as illustrated in FIG. 9. In other words, at least one of the gear teeth of the helical gear 65 extends from an upstream end to a downstream end of the contact area in the rotation direction of the pressure roller 31.

The above-described configuration efficiently reflects the shape of the helical tooth-shaped projection 65a on the inner circumferential surface of the base layer 21a in the contact area on which the helical gear 65 is in contact with the base layer 21a and easily exhibits the effect of preventing the lubricant from leaking to the outside of the fixing belt 21.

As illustrated in FIG. 9, the helical tooth-shaped projection 65a has a flat tooth face generating the thrust force in the direction indicated by the white arrow in FIG. 9 in the contact area on which the helical gear 65 is in contact with the base layer 21a. In the above-described structure, an angle θ formed by the tooth face of the helical tooth-shaped projection 65a and the axis W is expressed as follows.

$$θ = {tan}^{- 1} ( Y / X ) .$$

where X is a face width of the helical tooth-shaped projection 65a (the tooth), and Y is the nip width of the contact area. Setting the angle θ to be larger than 0 degrees and smaller than 90 degrees can generate the thrust force in the direction indicated by the white arrow described above.

Preferably, the helical gear 65 as the ring is configured to generate the thrust force in the direction indicated by the white arrow not to move the fixing belt 21 in the width direction.

Since the above-described thrust force is generated by the helical tooth-shaped projections 65a rotating and pressing against the base layer 21a, the thrust force may shift the fixing belt 21 itself in the same direction. Considering the above, it is preferable that the frictional resistance between the helical gear 65 and the base layer 21a, a pressure contact amount, and the helix angle are designed to limit the thrust force not to cause the above-described belt shift.

Preferably, the surface roughness of a portion (as a first portion) of the inner circumferential surface of the fixing belt 21 facing the contact area on which the helical gear 65 contacts the base layer 21a is greater than the surface roughness of another portion (as a second portion) of the inner circumferential surface of the fixing belt 21 not facing the contact area. In other words, the inner circumferential surface of the fixing belt 21 has a first portion facing the contact area and a second portion not facing the contact area, and the surface roughness of the first portion is preferably designed to be larger than the surface roughness of the second portion.

As described above, the portion of the inner circumferential surface of the base layer 21a facing the contact area reflects the shape of the helical tooth-shaped projection 65a and projects in a helical tooth shape. Since a force gripping the lubricant on the surface having a large roughness is larger than a force gripping the lubricant on a smooth surface, the above-described thrust force easily exhibits the effect moving the lubricant to the center of the fixing belt 21 in the width direction.

The following describes a first modification.

As illustrated in FIG. 10A, the helical gear 65 according to the first modification includes the helical tooth-shaped projection 65a having a curved tooth face generating the thrust force in the direction indicated by the white arrow in FIG. 10A in the contact area on which the helical gear 65 is in contact with the base layer 21a. The helical tooth-shaped projection 65a does not have the flat tooth face as illustrated in FIG. 9. In FIG. 10A, the axis W extends in the axial direction, and the helical tooth-shaped projection 65a has a tooth face extending from one end to the other end in the axial direction. The other end of the tooth face is closer to the center of the fixing belt than the one end of the tooth face. As illustrated in FIG. 10A, the helical tooth-shaped projection 65a is formed so that an angle θ formed by the axis W and the tooth face at the other end is larger than an angle θ formed by the axis W and the tooth face at the one end. The angle θ formed by the axis W and the tooth face of the helical tooth-shaped projection 65a gradually increases from the one end of the helical tooth-shaped projection 65a toward the other end of the helical tooth-shaped projection 65a in the axial direction.

In the above-described configuration, a portion having the largest angle θ in the helical tooth-shaped projection 65a generates the largest thrust force pushing back the lubricant in the direction indicated by the white arrow. The portion can block the lubricant that moves outward in the width direction (opposite to the direction indicated by the white arrow) and prevent the lubricant from leaking out from the fixing belt 21.

The shape of the helical tooth-shaped projection 65a is not limited to the shapes illustrated in FIGS. 9 and 10A. As long as the shape of the helical tooth-shaped projection 65a generates the thrust force in the direction indicated by the white arrow, the helical tooth-shaped projection may have another shape such as a shape illustrated in FIG. 10B in which multiple curved faces are connected or a shape illustrated in FIG. 10C in which multiple flat faces are connected. In particular, the helical tooth-shaped projection 65a illustrated in FIG. 10C has the angles θ1 to θ3 increasing stepwise from one end to the other end in the axial direction, and thus the same effect as that of FIG. 10A can be obtained. The tooth face may have at least one of the flat face or the curved face. Basically, when the tooth face of the helical gear 65 has the one end as the first end farthest from the center of the shaft of the pressure roller 31 in the axial direction and another portion other than the one end, and when an angle formed by the axial direction and said another portion is larger than an angle formed by the axial direction and the one end, said another portion generates a larger thrust force pushing back the lubricant toward the center of the fixing belt than the one end. This configuration also prevents the lubricant from leaking out of the fixing belt.

The following describes a second modification.

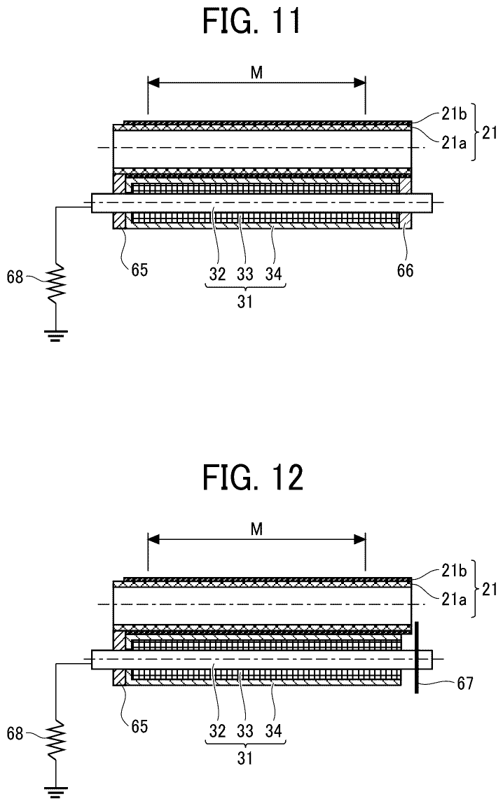

As illustrated in FIG. 11, the fixing device 20 according to the second modification includes a helical gear 66 as the ring disposed on the other end of the pressure roller 31 in the width direction (that is the right end of the pressure roller 31 in FIG. 11) in addition to the helical gear 65 disposed on the above-described one end of the pressure roller 31 in the width direction.

The helical gear 66 on the other end in the width direction also has multiple helical tooth-shaped projections inclined with respect to the axial direction on the entire outer peripheral portion of the helical gear 66 in the circumferential direction.

The helical tooth-shaped projection is inclined in a direction that generates a thrust force toward the center of the fixing belt 21 in the axial direction (a thrust force toward the left side in FIG. 11), the thrust force applied to the other end of the fixing belt in a contact area on which the fixing belt contacts the helical gear 66 rotating (the contact area on which the belt surface layer 21b contacts the helical gear 66 rotating in the example of FIG. 11). In other words, the helical gear 66 on the other end in the width direction is twisted in a direction opposite to the helical gear 65 on the one end in the width direction.

The helical gear 66 does not function as the conductor to ground the base layer 21a and the conductive surface layer 34. The helical gear 66 functions as the lubricant leakage preventing member that prevents the lubricant applied to the inner circumferential surface of the fixing belt 21 from leaking from the other end of the fixing belt 21 in the width direction. Accordingly, the helical gear 66 may not be made of conductive material.

In the above-described configuration, similarly to the above embodiment, the lubricant applied to the inner circumferential surface of the fixing belt 21 is less likely to leak out of the fixing belt 21.

The following describes a third modification.

As illustrated in FIG. 12, the fixing device 20 according to the third modification includes a restrictor 67 that restricts movement of the fixing belt 21 in the width direction (i.e., a belt deviation toward the right side in FIG. 12) caused by the thrust force of the helical gear 65 as the ring.

Specifically, the restrictor 67 includes a doughnut-shaped plate disposed on the cored bar 32 as the shaft of the pressure roller 31, and the outer diameter of the doughnut-shaped plate is larger than the roller diameter of the pressure roller 31 such that the end face of the fixing belt 21 can contact the doughnut-shaped plate.

The helical tooth-shaped projections 65a are in pressure contact with the base layer 21a, rotate and generate the thrust force. The thrust force is likely to displace the fixing belt 21 itself in the direction of the thrust force. In the above-described configuration, the restrictor 67 interferes with the end face of the fixing belt 21 to prevent the fixing belt 21 from further displacing.

The flange 42 described with reference to FIG. 4 may have such a function as the restrictor.

As described above, the fixing device 20 according to the present embodiment includes the planar heater 24 as the heater, the lubricant, the fixing belt 21, the pressure roller 31 as the pressure rotator, the helical gear 65 as the ring. The planar heater 24 heats the fixing belt 21. The lubricant is directly or indirectly applied to the inner circumferential surface of the fixing belt 21. The pressure roller 31 is pressed against the fixing belt 21 to form the fixing nip through which the sheet P is conveyed. The helical gear 65 rotates together with the pressure roller 31. The helical gear 65 is disposed on the cored bar 32 as the shaft of the pressure roller 31 so as to contact the end of the fixing belt 21 in the width direction. The helical gear 65 has multiple helical tooth-shaped projections 65a inclined with respect to the axial direction on the entire outer peripheral portion of the helical gear 65 in the circumferential direction. The helical tooth-shaped projection 65a is inclined in a direction that generates the thrust force toward the center of the fixing belt 21 in the axial direction when the helical tooth-shaped projection 65a rotates together with the pressure roller 31, and the thrust force acts on the fixing belt in the contact area in which the helical tooth-shaped projection 65a contacts the fixing belt 21. Accordingly, the lubricant applied to the inner circumferential surface of the fixing belt 21 is less likely to leak out of the fixing belt 21.

In the above embodiments and modifications, the present disclosure is applied to the fixing device 20 including the planar heater 24 as the heater. However, the fixing device to which the present disclosure is applied is not limited to this. For example, the present disclosure may be applied to the fixing device including an electromagnetic induction coil as the heater.

In the above embodiments and modifications, the fixing belt 21 includes the base layer 21a as the belt conductive layer. Alternatively, the fixing belt 21 may include the belt surface layer 21b and a conductive elastic layer sequentially layered on the base layer 21a to form the three layer structure. In this case, the belt surface layer 21b is indirectly layered over the base layer 21a. The belt surface layer 21b directly or indirectly layered over the base layer 21a may be expressed as the belt surface layer over the base layer. The conductive elastic layer may be used as the belt conductive layer.

In the above embodiments and modifications, the fixing device includes the helical gear 65 as the ring. However, the ring does not necessarily have to be the helical tooth shape. The ring is enough to include the multiple helical tooth-shaped projections 65a formed on the entire outer peripheral portion of the ring in the circumferential direction and inclined with respect to the axial direction in a direction that generates the thrust force toward the center of the fixing belt in the axial direction when the helical tooth-shaped projections 65a rotate, and the thrust force acts on the fixing belt in the contact area.

In the above embodiments and modifications, the planar heater 24 as the heater serves as the nip formation pad and is pressed against the pressure roller 31 via the fixing belt 21 to form the fixing nip. However, the nip formation pad may not be the heater.

The above-described configurations also provide similar effects to those of the above-described embodiments and the modifications.

Note that embodiments of the present disclosure are not limited to the above-described embodiments, and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

In the present description, the term “sheet” is defined as any sheet-like recording medium including all conveyed objects, such as typical paper, coated paper, label paper, overhead projector (OHP) transparency, or a film sheet.

Note that aspects of the present disclosure may be applicable to, for example, combinations of first to thirteenth aspects as follows.

### First Aspect

In a first aspect, a fixing device has the following feature. The fixing device according to the first aspect includes lubricant, a heat source, a fixing belt, a pressure rotator, and a ring. The lubricant is directly or indirectly applied to an inner circumferential surface of the fixing belt. The heater heats the fixing belt. The pressure rotator is pressed against the fixing belt to form a fixing nip through which a sheet is conveyed. The ring contacts an end of the fixing belt in a width direction of the fixing belt and is disposed on a shaft of the pressure rotator. The ring rotates together with the pressure rotator. The ring includes multiple helical tooth-shaped projections inclined with respect to an axial direction of the pressure rotator on an entire outer peripheral portion of the ring in a circumferential direction of the ring. The multiple helical tooth-shaped projections are inclined so as to generate a thrust force toward a center of the fixing belt in the axial direction, the thrust force that acts on a contact area on which the fixing belt contacts the helical tooth-shaped projections.

### Second Aspect

In a second aspect, the fixing device according to the first aspect has the following feature. The fixing belt includes a belt conductive layer having conductivity and a belt surface layer having an insulating property or a medium resistance. The belt surface layer is directly or indirectly layered on a part of the belt conductive layer other than the contact area in the width direction. The pressure rotator includes a conductive surface layer contacting the belt surface layer of the fixing belt to form the fixing nip. The ring has conductivity, contacts the belt conductive layer and the conductive surface layer, and is grounded.

### Third Aspect

In a third aspect, the fixing device according to the first aspect or the second aspect has the following feature. The ring includes a helical gear made of conductive rubber.

### Fourth Aspect

In a fourth aspect, the fixing device according to any one of the first to third aspects has the following feature. The fixing belt has a two layer structure including a belt surface layer layered on a belt conductive layer as a base layer.

### Fifth Aspect

In a fifth aspect, the fixing device according to any one of the first to fourth aspects has the following feature. The fixing belt has a surface roughness of a part of the inner circumferential surface corresponding to the contact area that is larger than a surface roughness of the inner circumferential surface other than the part.

### Sixth Aspect

In a sixth aspect, the fixing device according to any one of the first to fifth aspects has the following feature. A position of an end of the fixing belt in the width direction substantially coincides with a position of an end of the helical tooth-shaped projection of the ring in the axial direction.

### Seventh Aspect

In a seventh aspect, the fixing device according to any one of the first to sixth aspects has the following feature. The ring includes at least one of the multiple helical tooth-shaped projections that extends over a nip width of the contact area.

### Eighth Aspect

In an eighth aspect, the fixing device according to any one of the first to seventh aspects has the following feature. The helical tooth-shaped projection has a tooth face generating the thrust force acting on the contact area, and the tooth face has at least one of a flat face or a curved face.

### Ninth Aspect

In a ninth aspect, the fixing device according to the eighth aspect has the following feature. The helical tooth-shaped projection has the tooth face having one end and the other end in the axial direction, and an angle formed by the tooth face at the other end and an axis extending in the axial direction is larger than an angle formed by the tooth face at the above-described one end and the axis in the axial direction.

### Tenth Aspect

In a tenth aspect, the fixing device according to any one of the first to ninth aspects has the following feature. The fixing device according to the tenth aspect includes a planar heater as the heat source contacting the inner circumferential surface of the fixing belt and is in pressure contact with the pressure rotator via the fixing belt to form the fixing nip.

### Eleventh Aspect

In an eleventh aspect, the fixing device according to any one of the first to tenth aspects has the following feature. The ring is configured to prevent the fixing belt from being moved in the width direction by the thrust force.

### Twelfth Aspect

In a twelfth aspect, the fixing device according to any one of the first to eleventh aspects has the following feature. The fixing device according to the twelfth aspect includes a restrictor to restrict movement of the fixing belt in the width direction caused by the thrust force of the ring.

### Thirteenth Aspect

In a thirteenth aspect, an image forming apparatus includes the fixing device according to any one of the first to twelfth aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fixing device comprising:
a fixing belt;
a heater to heat the fixing belt;
lubricant applied to an inner circumferential surface of the fixing belt;
a pressure rotator:
pressed against the fixing belt to form a fixing nip through which a sheet is conveyed; and
including a shaft, extending in an axial direction, around which the pressure rotator rotates in a rotation direction; and
a helical gear having gear teeth, the helical gear:
disposed on one end of the shaft of the pressure rotator; and
rotatable with the pressure rotator in the rotation direction,
wherein the gear teeth contact one end of the fixing belt that faces the one end of the shaft in the axial direction to form a contact area,
each of the gear teeth has a tooth face inclined with respect to the axial direction in the contact area,
the tooth face has:
a first end farthest from a center of the shaft in the axial direction; and
a second end closer to the center than the first end in the axial direction, and
the second end is at a downstream side of the first end in the rotation direction.

2. The fixing device according to claim 1,
wherein the fixing belt includes:
a belt conductive layer; and
a belt surface layer over a part of the belt conductive layer other than the one end of the fixing belt facing the contact area in the axial direction,
the belt surface layer has a resistance larger than the belt conductive layer,
the pressure rotator includes a conductive surface layer contacting the belt surface layer of the fixing belt to form the fixing nip, and
the helical gear:
has conductivity and is grounded; and
contacts each of the belt conductive layer and the conductive surface layer.

3. The fixing device according to claim 2,
wherein the helical gear is made of conductive rubber.

4. The fixing device according to claim 2,
wherein the fixing belt has a two layer structure including:
the belt conductive layer as a base layer; and
the belt surface layer on the belt conductive layer.

5. The fixing device according to claim 1,
wherein the inner circumferential surface of the fixing belt has:
a first portion facing the contact area, the first portion having a first surface roughness; and
a second portion not facing the contact area, the second portion having a second surface roughness smaller than the first surface roughness.

6. The fixing device according to claim 1,
wherein the first end of the tooth face is aligned at an edge of the one end of the fixing belt in the axial direction.

7. The fixing device according to claim 1,
wherein at least one of the gear teeth of the helical gear extends from an upstream end to a downstream end of the contact area in the rotation direction.

8. The fixing device according to claim 1,
wherein the tooth face has at least one of a flat face or a curved face.

9. The fixing device according to claim 8,
wherein the tooth face has another portion other than the first end, and
an angle formed by the axial direction and said another portion is larger than an angle formed by the axial direction and the first end.

10. The fixing device according to claim 1,
wherein the heater includes a planar heater contacting the inner circumferential surface of the fixing belt and being pressed against the pressure rotator via the fixing belt to form the fixing nip.

11. The fixing device according to claim 1,
wherein the helical gear is configured to generate a thrust force toward the center of the fixing belt in the axial direction not to move the fixing belt in the axial direction.

12. The fixing device according to claim 1, further comprising:
a restrictor to restrict a movement of the fixing belt in the axial direction.

13. An image forming apparatus comprising the fixing device according to claim 1.

14. A fixing device comprising:
a fixing means including lubricant;
a pressing means for pressing the fixing means to form a fixing nip while rotating about a shaft having an axial direction; and
a means for generating a thrust force toward a center of the fixing means in the axial direction and applying the thrust force to the lubricant in the fixing means by using the rotation of the pressing means.
